(19) United States
(12) Patent Application Publication
(10) Pub. No.: US 2026/0136234 A1
(43) Pub. Date: May 14, 2026

(54) SEAMLESS LOW LATENCY, LOW LOSS, SCALABLE THROUGHPUT (L4S) QUALITY-OF-SERVICE (QOS) MAINTENANCE DURING ROAMING

(71) Applicant: Cisco Technology, Inc., San Jose, CA (US)

(72) Inventors: Ardalan Alizadeh, Milpitas, CA (US); Peiman Amini, Fremont, CA (US); Matthew Aaron Silverman, Shaker Heights, OH (US); Jerome Henry, Pittsboro, NC (US); Binita Gupta, San Diego, CA (US)

(73) Assignee: Cisco Technology, Inc., San Jose, CA (US)

(21) Appl. No.: 19/207,478

(22) Filed: May 14, 2025

Related U.S. Application Data
(60) Provisional application No. 63/718,831, filed on Nov. 11, 2024.

(51) Int. Cl. H04W 28/02

(52) U.S. Cl. CPC H04W 28/0268; H04W 28/0273; H04W 28/0289

(57) ABSTRACT

Seamless Low Latency, Low Loss, Scalable Throughput (L4S) Quality-of-service (QoS) maintenance during roaming may be provided. A client device may send Fast Transition (FT) protocol messages to an Access Point (AP). Then the client device may receive the FT protocol messages from the AP. At least one of the FT protocol messages may comprise Low Latency, Low Loss, Scalable Throughput (L4S) session parameters.

### RELATED APPLICATION

Under provisions of 35 U.S.C. § 119(e), Applicant claims the benefit of U.S. Provisional Application No. 63/718,831 filed Nov. 11, 2024, which is incorporated herein by reference.

### TECHNICAL FIELD

The present disclosure relates generally to providing Seamless Low Latency, Low Loss, Scalable Throughput (L4S) Quality-of-service (QoS) maintenance during roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Seamless Low Latency, Low Loss, Scalable Throughput (L4S) Quality-of-service (QoS) maintenance during roaming;

FIG. 2 is a flow chart of a method for providing Seamless L4S QoS maintenance during roaming;

FIG. 3 illustrates client devices parsing new Information Elements (IEs) from APs; and

FIG. 4 is a block diagram of a computing device.

### DETAILED DESCRIPTION

### Overview

Seamless Low Latency, Low Loss, Scalable Throughput (L4S) Quality-of-service (QoS) maintenance during roaming may be provided. A client device may send Fast Transition (FT) protocol messages to an Access Point (AP). Then the client device may receive the FT protocol messages from the AP. At least one of the FT protocol messages may comprise Low Latency, Low Loss, Scalable Throughput (L4S) session parameters.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Despite the rapid evolution of fast roaming protocols, conventional Wi-Fi roaming processes may introduce latency and packet loss as mobile client devices switch between APs. This may impact the performance of latency-sensitive applications. The Low Latency, Low Loss, Scalable Throughput (L4S) architecture may provide low latency and loss, but maintaining these characteristics during roaming remains challenging due to the variability in wireless conditions and the time it takes to re-establish L4S parameters with a new AP. Accordingly, embodiments of the disclosure may address the aforementioned challenges through a process that may coordinate between L4S state information with enhanced fast roaming protocols such as Institute of Electrical and Electronics Engineers (IEEE) 802.11r. This may facilitate the transfer of session parameters to new APs being associated with. Furthermore, the solution may employ a predictive model for the dynamic adjustment of L4S parameters, leveraging historical AP data and projected client trajectories.

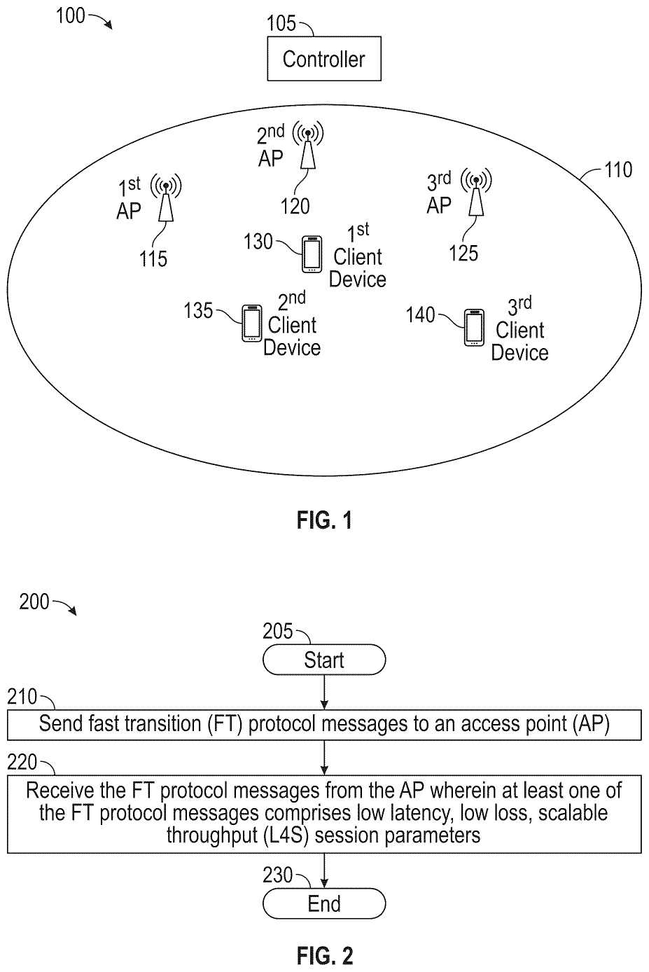

FIG. 1 shows an operating environment 100 for providing Seamless Low Latency, Low Loss, Scalable Throughput (L4S) Quality-of-service (QoS) maintenance during roaming. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and the plurality of client devices may also have an Ultra-Wide Band (UWB) radio that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide seamless L4S QoS maintenance during roaming.

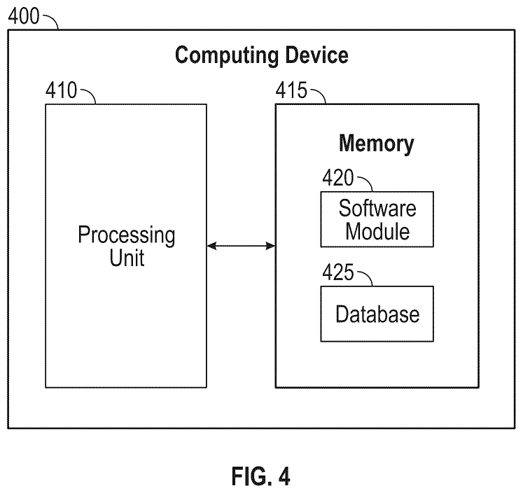

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

### Fast Roaming Protocol Enhancement

FIG. 2 is a flow chart setting forth the general stages involved in a method 200 consistent with embodiments of the disclosure for providing seamless L4S QoS maintenance during roaming. Method 200 may be implemented using a computing device 400 as described in more detail below with respect to FIG. 4. Computing device 400 may be embodied by any of the plurality of client devices, for example, first client device 130. Ways to implement the stages of method 200 will be described in greater detail below.

To mitigate the negative effects of latency and packet loss during Wi-Fi roaming, for example in the context of the L4S architecture, embodiments of the disclosure may enhance the IEEE 802.11r fast roaming protocol. These enhancements may facilitate a swift and seamless transition of L4S-specific session parameters to new APs being roamed to. This may reduce the handover time and ensure a consistent QoS for latency-sensitive applications for example.

Method 200 may begin at starting block 205 and proceed to stage 210 where computing device 400 (e.g., first client device 130) may send Fast Transition (FT) (e.g., IEEE 802.11r) protocol messages to an AP (e.g., second AP 120). For example, the FT protocol messages may comprise FT request and response frames used to expedite the key exchange process between first client device 130 and a new AP (e.g., second AP 120) during a roam (e.g., from first AP 115). These frames may allow the client and the new AP to calculate the Pairwise Transient Key (PTK) in advance, enabling a faster re-association.

With FT roaming there are two processes: i) Over-the-Air (OTA) and ii) Over-the-Distribution System (DS). With OTA, the client device communicates directly with the target AP being roamed to using IEEE 802.11 authentication with the FT authentication algorithm. The FT authentication request and response frames are exchanged directly between the client device and the target AP. With DS, the client device communicates with the target AP being roamed to through the current AP that the client device is associated with. The client device first sends an FT authentication request to the current AP, which then forwards the request to the target AP via the controller. The FT authentication response is then sent from the target AP back to the current AP, which then forwards it to the client device.

From stage 210, where computing device 400 (e.g., first client device 130) sends FT protocol messages to the AP (e.g., second AP 120), method 200 may advance to stage 220 where computing device 400 may receive the FT protocol messages from the AP. At least one of the FT protocol messages may comprise Low Latency, Low Loss, Scalable Throughput (L4S) session parameters. For example, L4S state information may be embedded within the FT protocol messages. This may comprise modifying the FT protocol's key exchange process to include L4S session parameters, such as congestion control algorithms and Active Queue Management (AQM) settings. This may allow for a seamless transition to the new AP without the need for renegotiation.

The FT request and response frames, which may facilitate the actual handover process, may be extended to include L4S parameters as optional Information Elements (IEs) to carry L4S session parameters. These IEs may comprise, but are not limited to, a congestion control algorithm identifier, AQM configuration data, and L4S identifiers. The congestion control algorithm identifier may specify the algorithm used by the client device, such as Cubic, Bottleneck Bandwidth and Round-trip (BBR) propagation time, etc. The AQM configuration data may detail the AQM settings employed, for example, Fair Queuing Controlled Delay (FQ-CoDel) or Random Early Detection (RED) parameters. The L4S identifiers may identify the L4S session to ensure continuity before and after the roam.

Existing legacy IEs may be modified to include flags or identifiers indicating L4S compatibility or requirements. For example, the Extended Capabilities IE (i.e., IE ID: 127) may provide a flexible format to indicate support for optional capabilities. Extended Capabilities IE may comprise one or more octets, with each bit representing a different capability. To integrate L4S compatibility indicators, embodiments of the disclosure may allocate specific bits within the Extended Capabilities IE to signify L4S support and specific L4S features.

For example, Extended Capabilities IE may be used to signify a L4S Support Flag. This may comprise a dedicated bit within the Extended Capabilities IE designated as the L4S Support Flag. If set to 1 for example, this flag may indicate that the device supports the L4S architecture and may engage in L4S-specific parameter negotiation and state synchronization.

Furthermore, Extended Capabilities IE may be used to signify an AQM Support Indicator. For example, another bit or set of bits may be used to indicate support for specific AQM algorithms compatible with L4S, such as Proportional Integral controller Enhanced (PIE) or FQ-CoDel. This may allow client devices to understand the AQM capabilities of the network and adjust their behavior accordingly.

Moreover, Extended Capabilities IE may be used to signify Congestion Control Algorithm Support. For example, additional bits may indicate support for specific congestion control algorithms that may be optimized for L4S, like Transmission Control Protocol (TCP) Prague. This may enable a more informed decision-making process during AP selection and roaming, ensuring client devices connect to APs that may support their preferred congestion control process. Once computing device 400 receives the FT protocol messages from the AP in stage 220, method 200 may then end at stage 230.

### Ap Mobility Domain Determination

Embodiments of the disclosure may provide a discovery process for APs to broadcast their membership in a single mobility domain. This may be achieved by extending the beacon and probe response frames to include a Mobility Domain Identifier (MDI), enabling the client device to pre-determine potential roam targets that share L4S policies and configurations.

In one embodiment, this determination may be developed as a predictive algorithm that may use, for example, signal strength, historical data, and client trajectory to select an optimal AP within the mobility domain for roaming to. This algorithm may factor in not only the signal strength, but also the load and performance characteristics of potential target APs to predict the best handover candidate.

Client devices may report back their anticipated movement direction and speed based, for example, on internal sensors like Global Positioning System (GPS) or accelerometer data, to the current AP. The AP may then use this data in conjunction with its knowledge of the network topology to suggest the next best AP for handover, optimizing roaming decisions.

### Inter-AP Communication for Smoother Handovers

Embodiments of the disclosure may provide messages or extend existing ones (e.g., IEEE 802.11v Wireless Network Management (WNM) frames) to include, for example, AP load information or L4S readiness status. The AP load information may comprise the current user count, data rate capacity, and resource utilization. L4S readiness status may comprise indicators of L4S parameter optimization, such as AQM configuration status and congestion window size.

APs may collect current capacity to accept new clients without degrading QoS, based on predefined thresholds of user count, bandwidth usage, and processing capacity. Upon determining its readiness, an AP may broadcast its status through the extended WNM frames or the newly defined protocol messages. This broadcast may include both the AP's load information and its L4S readiness status. The client device may evaluate the received information to choose an AP that signals optimal readiness, thus ensuring a higher quality of service post-handover.

### Selective AP Handover Based on L4S Compatibility

Embodiments of the disclosure may allow APs to broadcast L4S compatibility and performance levels to enable client devices to select APs that promise better service continuity and QoS. AP firmware may be configured to include additional IEs in beacon and probe response frames. These IEs may carry: i) an L4S Compatibility Flag comprising a binary flag indicating whether the AP supports L4S; or ii) Performance Metrics comprising quantitative data on current latency and packet loss rates, and optionally, historical performance metrics.

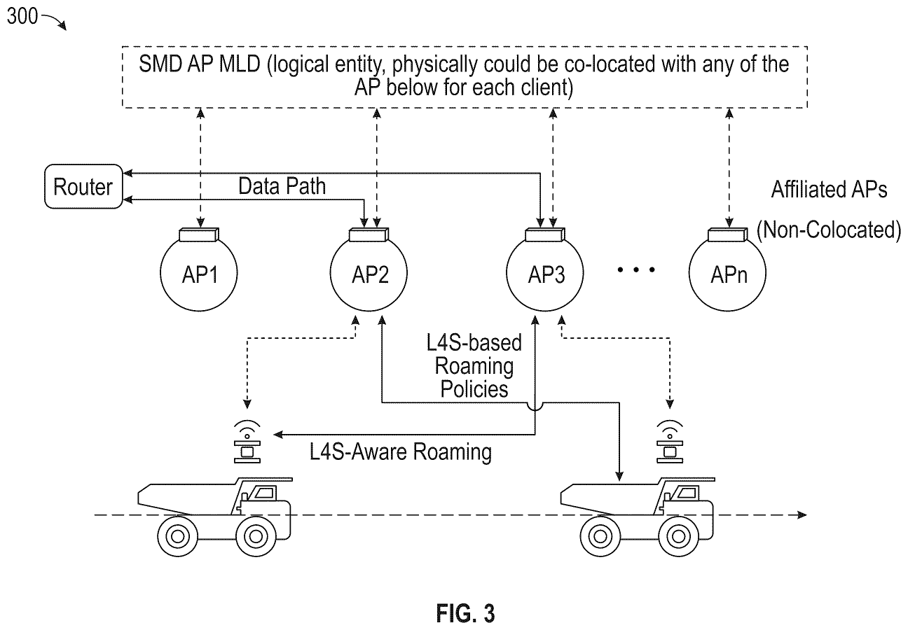

As described above, FIG. 3 illustrates client devices parsing new IEs from APs. A decision-making algorithm may be used on the client device side that may consider both L4S compatibility and the AP's current and predicted performance metrics when selecting an AP for roaming to.

Accordingly, embodiments of the disclosure may provide enhancements to the IEEE 802.11r fast roaming protocol that may mitigate latency and packet loss during Wi-Fi roaming within the L4S architecture framework. By embedding L4S state information into FT protocol messages and defining IEs for conveying L4S session parameters, embodiments of the disclosure may provide a seamless transition of session parameters to new APs. Additionally, embodiments of the disclosure may provide a discovery mechanism for AP mobility domain determination and may advocate for enhanced inter-AP communication to indicate readiness and L4S compatibility.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing seamless L4S QoS maintenance during roaming as described above with respect to FIG. 2. Computing device 400, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
sending, by a client device, Fast Transition (FT) protocol messages to an Access Point (AP); and
receiving, by the client device, the FT protocol messages from the AP wherein at least one of the FT protocol messages comprises Low Latency, Low Loss, Scalable Throughput (L4S) session parameters.

2. The method of claim 1, wherein at least one of the FT protocol messages comprises a congestion control algorithm identifier Information Element (IE) that specifies a congestion control algorithm used by the client device.

3. The method of claim 1, wherein at least one of the FT protocol messages comprises an Active Queue Management (AQM) Information Element (IE) that specifies AQM settings used by the client device.

4. The method of claim 1, wherein at least one of the FT protocol messages comprises an L4S Identifier Information Element (IE) that specifies an L4S session.

5. The method of claim 1, wherein at least one of the FT protocol messages comprises an FT request.

6. The method of claim 1, wherein at least one of the FT protocol messages comprises an FT response.

7. The method of claim 1, further comprising receiving, by the client device from the AP, a Mobility Domain Identifier (MDI).

8. The method of claim 1, further comprising providing by the AP a message indicating AP load information.

9. The method of claim 1, further comprising providing by the AP a message indicating L4S readiness status.

10. A system comprising:
a memory storage; and
a processing unit disposed in a client device and coupled to the memory storage, wherein the processing unit is operative to:
send Fast Transition (FT) protocol messages to an Access Point (AP); and
receive the FT protocol messages from the AP wherein at least one of the FT protocol messages comprises Low Latency, Low Loss, Scalable Throughput (L4S) session parameters.

11. The system of claim 10, wherein at least one of the FT protocol messages comprises a congestion control algorithm identifier Information Element (IE) that specifies a congestion control algorithm used by the client device.

12. The system of claim 10, wherein at least one of the FT protocol messages comprises an Active Queue Management (AQM) Information Element (IE) that specifies AQM settings used by the client device.

13. The system of claim 10, wherein at least one of the FT protocol messages comprises an L4S Identifier Information Element (IE) that specifies an L4S session.

14. The system of claim 10, wherein at least one of the FT protocol messages comprises one of an FT request and an FT response.

15. A non-transitory computer-readable medium that stores a set of instructions which when executed perform a method executed by the set of instructions comprising:
sending, by a client device, Fast Transition (FT) protocol messages to an Access Point (AP); and
receiving, by the client device, the FT protocol messages from the AP wherein at least one of the FT protocol messages comprises Low Latency, Low Loss, Scalable Throughput (L4S) session parameters.

16. The non-transitory computer-readable medium of claim 15, wherein at least one of the FT protocol messages comprises a congestion control algorithm identifier Information Element (IE) that specifies a congestion control algorithm used by the client device.

17. The non-transitory computer-readable medium of claim 15, wherein at least one of the FT protocol messages comprises an Active Queue Management (AQM) Information Element (IE) that specifies AQM settings used by the client device.

18. The non-transitory computer-readable medium of claim 15, wherein at least one of the FT protocol messages comprises an L4S Identifier Information Element (IE) that specifies an L4S session.

19. The non-transitory computer-readable medium of claim 15, wherein at least one of the FT protocol messages comprises an FT request.

20. The non-transitory computer-readable medium of claim 15, wherein at least one of the FT protocol messages comprises an FT response.
